(19) United States
(12) Patent Application Publication
(10) Pub. No.: US 2005/0037741 A1
(43) Pub. Date: Feb. 17, 2005

(54) System and method for telephonic presence via e-mail and short message service

(75) Inventor: Leroy Edwin Gilbert, Wellington, FL (US)

Correspondence Address: Elsa Keller;Siemens Corporation, Intellectual Property Department, 170 Wood Avenue South, Iselin, NJ, 08830, US

(73) Assignee: Siemens Information and Communication Networks, Inc.

(21) Appl. No.: 10/639,233

(22) Filed: Aug. 12, 2003

(51) Int. Cl. H04Q 7/20

(52) U.S. Cl. 455/414.1; 455/466; 455/414.4

(57) ABSTRACT

A telecommunications device includes a broker module that translates telephone, mail and presence status information into short coded plain-text strings suitable for transmission over low-speed, high latency, high-cost IP networks. The broker module further transmits and receives such messages, to allow a user to monitor voicemail, e-mail, IM, and presence status, as well as control various telephone functions remotely.

### FIELD OF THE INVENTION

The present invention relates to telecommunications systems and, in particular, to an improved system and method for telephone features.

### BACKGROUND OF THE INVENTION

The widespread availability of wireless cellular telephones and personal digital assistants (PDAS) has led to increased interest in replacing or at least extending desktop telephone features to the wireless environment. While desktop telephone devices are increasingly used in conjunction with features available on Internet Protocol (IP) based local area networks, public wireless IP networks are still relatively expensive to use, suffer from low bandwidth and high latency, and do not provide service suitable for voice or standard desktop applications. Features like presence and Instant Messaging applications are available over wireless networks. However, these networks are not suitable for voice transmission due to latency, bandwidth limitations, and cost. In addition, such features are typically not available to cell phone users unless they have a wireless modem connection to the Internet, which blocks normal voice traffic.

As such, there is a need for an improved system and method for accessing telephone features over a wireless network.

### SUMMARY OF THE INVENTION

These and other drawbacks in the prior art are overcome in large part by a system and method according to embodiments of the present invention.

A telecommunications device according to embodiments of the present invention includes a broker module that translates telephone control, mail and presence status information into short coded plain-text strings suitable for transmission over low-speed, high latency, high-cost IP networks. The broker module further transmits and receives such messages, to allow a user to monitor voicemail, e-mail, IM, and presence status, as well as control various telephone functions remotely.

A telecommunications system according to embodiments of the present invention includes a cellular voice network and an Internet Protocol control network. A text-based protocol is used to control functions of various devices while the cellular voice network is used to complete any required voice connections. This allows remote users to, for example, make and answer calls while at the remote location; control telephone features such as forwarding; listen to voice messages; and set presence state.

A telecommunications system according to an embodiment of the present invention includes a wireless packet network; a cellular telephone network; a server for interfacing the wireless packet network and the cellular telephone network. The server includes a controller adapted to send and receive predetermined text commands suitable for sending over a transport protocol on low speed networks, over the wireless packet network for control of functions of the cellular telephone network, in order to operate the two networks economically as a single coordinated network for voice, status, and control.

A better understanding of these and other specific embodiments of the invention is obtained when the following detailed description is considered in conjunction with the following drawings.

### BRIEF DESCRIPTION OF THE DRAWINGS

FIG. 1 is a diagram illustrating a telecommunications system according to an embodiment of the present invention;

FIG. 2 is a block diagram of a telecommunications device according to an embodiment of the present invention;

FIG. 3A and FIG. 3B illustrate a remote client according to an embodiment of the present invention;

FIG. 4 is a diagram illustrating a user interface according to an embodiment of the present invention;

FIG. 5 is a diagram illustrating a user interface according to an embodiment of the present invention;

FIG. 6 is a signaling diagram illustrating operation of an embodiment of the present invention;

FIG. 7 is a signaling diagram illustrating operation of an embodiment of the present invention;

FIG. 8 is a signaling diagram illustrating operation of an embodiment of the present invention.

### DETAILED DESCRIPTION OF EMBODIMENTS OF THE INVENTION

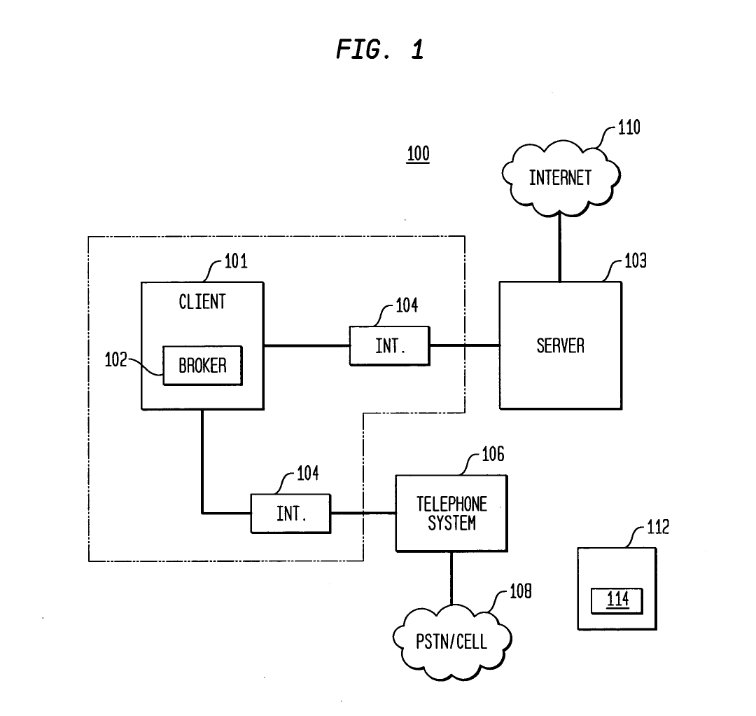

Turning now to the drawings and, with particular attention to FIG. 1, a multimedia telecommunications system according to an embodiment of the present invention is shown and generally identified by the reference numeral 100. As shown, the telecommunications system includes a client device 101 having a broker module 102 according to embodiments of the present invention. The broker module 102 allows for transmission and reception of control information as coded text-strings, as will be explained in greater detail below. The broker module 102 thus maintains one or more databases of protocol commands and is capable of translating those commands into formats readable by one or more servers 103. More particularly, the servers 103 interact with network interfaces 104 to provide services to the client device 101. For example, the server 103 may be embodied as a multimedia server including one or more of a presence server, an Instant Messaging server, an e-mail server, and the like. An exemplary multimedia server is a Microsoft .Net-based server. Instant Messaging with presence and E-mail services may be provided by Microsoft Instant Messenger and Outlook, respectively, though other electronic messaging servers may be suitable, as well.

The client device 101 may be implemented as a personal computer having one or more of e-mail, instant messaging, presence, and telephone capabilities, as will be described in greater detail below. Further, while the client device 101 may be a standalone device, it may also be implemented as one of a plurality of devices on a wired or wireless local area network employing a multimedia protocol, such as Session Initiation Protocol (SIP) or Recommendation H.323. The client device 101 communicates via one or more network interfaces 104 to an IP network, such as the Internet 110. Similarly, the client device 101 can communicate via a telephone system 106 to the public switched telephone or cellular networks 108.

As will be described in greater detail below, a remote device 112 may include a protocol module 114 for communicating with the broker 102 and controlling various functionalities of the device 101. The remote device 112 may be implemented having a variety of functions, such as a personal digital assistant (PDA) with or without cellular telephone capabilities, but with wireless Internet access. The remote device 112 may communicate over the Internet 110 using any of a variety of protocols, such as SMS (Simple Message Service), SMTP (Simple Mail Transfer Protocol), TCP (Transmission Control Protocol), or HTTP (Hypertext Transfer Protocol). Typically, voice is provided over the PSTN or cellular network 108, but in certain embodiments may be provided via the IP network 110.

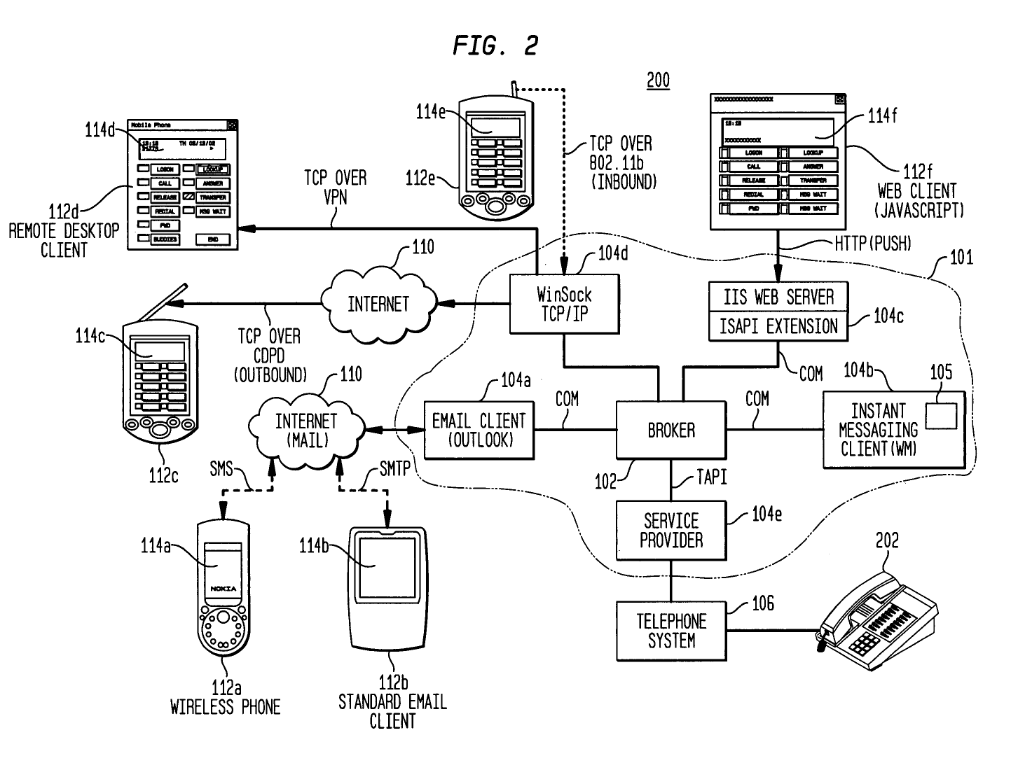

Turning now to FIG. 2, a diagram illustrating in greater detail the variety of user interfaces and transport technologies that can be used in conjunction with the present invention is shown. Shown in FIG. 2 is network client 101 having a broker module 102. The network client 101 also includes a plurality of network interfaces 104a-104e. In the embodiment illustrated, these include an e-mail client 104a, an Instant Messaging client 104b, an IIS server client 104c, a Winsock TCP/IP client 104d, and a TAPI service provider module 104e.

As will be explained in greater detail below, the e-mail client 104a permits communication via the Internet 110 to wireless phones 112a (via SMS) or other wireless e-mail clients 112b (via SMTP). Similarly, the TAPI service provider module 104e allows communication with telephone system 106 and one or more standard telephones 202. The IIS web server 104c allows interfacing to one or more web clients 112f, via HTTP. Finally, the Winsock TCP/IP module 104d allows communication via TCP to wireless clients 112c, 112e, via 802.11 or CDPD, respectively, and to a remote desktop client 112d. The remote clients 112a-112f include protocol modules 114a-114f, respectively, according to embodiments of the present invention.

As will be discussed in greater detail below, the protocol module 114 (FIG. 1) in conjunction with the broker 102 provides remote users with a text-based low bandwidth system and method for remote access to telephone and presence functions. Status messages arriving at the remote client may be translated into a suitable user interface (e.g., in a PDA) or read as an e-mail or SMS message on cell phones. In certain embodiments, a cell phone equipped with J2ME capability can provide a user interface.

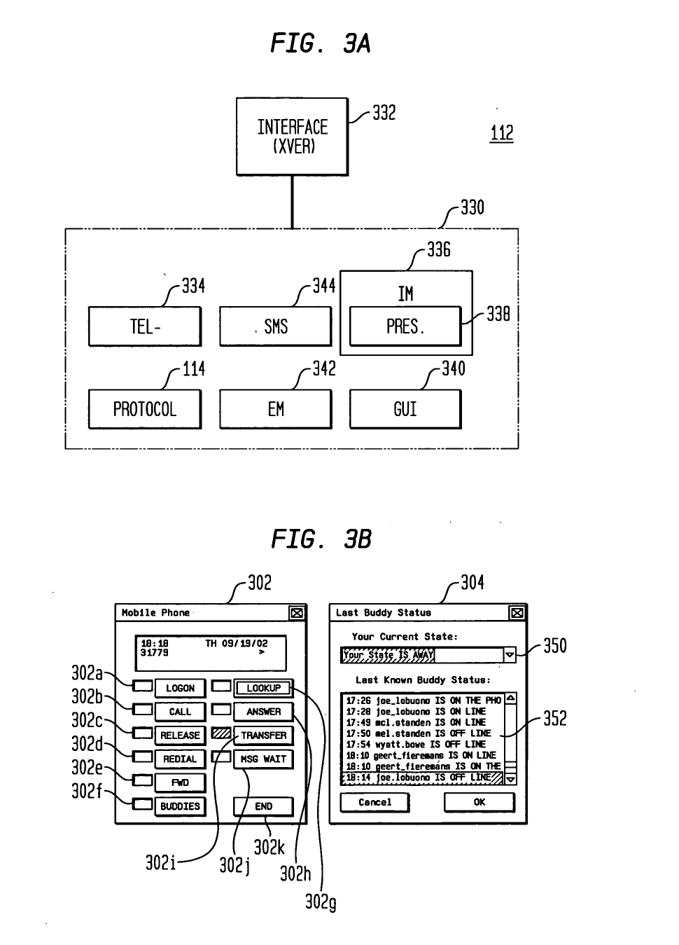

Turning now to FIG. 3A, a block diagram illustrating exemplary functionality of a remote client 112 is shown. As shown, the remote client 112 may include a controller 330, such as one or more microprocessors or microcontrollers, implementing one or more function modules 334, 336, 340, 342, 344, and 114. In the embodiment illustrated, the modules include a cellular telephone module 334, an Instant Messaging module 336 (including presence module 338), a text protocol module 114, a graphical user interface module 340, an e-mail module 342, and an SMS module 344. It is noted that, depending on the embodiment, fewer modules may be provided. The controller 330 couples to an interface 332 for access to the client 101, such as a network interface, in the case of a LAN remote client, or an air interface, in case of a cellular network remote client. The text protocol module 114 may include one or more databases allowing the client to identify and generate commands according to the protocol.

In operation, the user at the remote client 112 can generate one or more commands in the text-based protocol of the present invention for transmission to the local client 101. As will be explained in greater detail below, once entered, such as via the GUI 340, they can be transmitted using an IP interface, such as e-mail, SMS, or Instant Messaging. The remote client 112 can similarly receive commands in the text protocol via, e.g., SMS or E-mail, and display them via the GUI 340, either in a protocol specific window, or in the applications window itself.

An exemplary user interface is shown in FIG. 3B. In particular, shown are a phone window 302 and a buddy status window 304.

The mobile phone window 302 provides phone status, including such functions as Logon 302a, Call 302b, Release 302c, Redial 302d, Forward 302e, Buddies 302f, Lookup 302g, Answer 302h, Transfer 302i, Message Waiting 302j, and End 302k. As noted above, when using the phone window 302, the user can select one of the functions; the protocol module 114 will then translate the selected command into a suitable text protocol string and allow its transmission to the base client 101, via the IP medium selected or available. The base client 101 will then act on the received commands.

The Logon command 302a allows the user to access the client system 101. The Call command 302b allows the user to call make a call using the network client 101 from the remote client 112. The Release command 302c allows the user to release a call. The Redial command 302d lets the user redial a last number at the network client 101. The Forward command 302e allows the user to set a forwarding number at the network client 101. For example, the user can have calls to the network client 101 be directed to another telephone or the remote user 112, if the remote user is telephone-equipped. The Buddies command 302f allows the user to check or update the buddy list, e.g., for instant messaging or presence using the interface 304, as will be discussed in greater detail below. The Lookup command 302g allows the user to lookup a buddy name and/or subscriber telephone number on the network unit 101. The Answer command 302h lets the user answer a call on the network client 101. The Transfer command 302i, lets a user transfer using the network client 101. The Message Waiting command 302j allows the user to check if a message is waiting at the network client voice message system. The End command 302k allows the user to log off the network client.

In the embodiment illustrated, the buddy status window 304 includes a user status pull down 350 and a last known buddy status list 352. Presence status can include, for example, AWAY, ONLINE, ON THE PHONE, OFF LINE, etc. The presence information may be transmitted to and from the remote unit 112 via a presence or IM server. In operation, the user can select a current status from the dropdown menu 350 and have it transmitted to the network client 101 using the text based protocol of the present invention. In response, the network client 101 receives and translates the text message and causes the presence or IM system to update the user's status. Similarly, the network client can transmit to the remote client the presence status of users on the client's buddy list for display in window 352.

As noted above, an aspect of the present invention is providing a text-based protocol suitable for transmission over IP, HTTP, HTML, and SMS. Exemplary syntax and functionality for such a protocol is shown in Table 1 below:

TABLE 1
LIST OF SERVER COMMANDS (Client to Server)

| | |
|---|---|
| <PING> | Used to verify link is still working |
| <PRES> nn | Used to change presence state of client (e.g. busy, not |
| | available, traveling). “nn” is a numerical value that maps to |
| | the new presence state. |
| <QUIT> | Used to terminate a session. The link will be torn down. |
| <INFO> text | Used to send an information message to the server. The |
| | text message is recorded in the system log. |
| <LOGON> | Used to indicate to server where client is located (dialable |
| current_phone_number | phone number). |
| #time_sensitive_password | |
| <LOGOFF> | Used to indicate that the client is no longer reachable/ |
| | temporarily not reachable |
| <CALL> nnnnnnn | Used to originate a call. Server calls client first (at location |
| | previously specified) and then calls wanted destination, and |
| | connects the two calls. |
| <CONF> | Used to initiate a conference with two calls currently at the |
| | server. |
| <HANGUP> | releases current call to the associated phone |
| <XFER> nnnnnn | transfers the currently active phone call to a new number, |
| | returning the client telephone to idle. |
| <ANSWER> | answers a call currently alerting the user desk phone and |
| | then transfers it to the current client location (e.g. a hotel |
| | room). |
| <FWD NA> nnnnnnn | commands that activate call forwarding (various types) on |
| <FWD BUSY> nnnnnnn | the user desk telephone. If number is missing, command |
| <AND ALL> nnnnnnn | turns forwarding off. |
| <AND BUSYNA> nnnnn | |
| <MSGCB> nnnnnnnn | Used to connect client to voice mail system. Calls client at |
| | current location, then calls voice mail system, enters logon |
| | ID and password, then connects the two calls. If the field |
| | number is missing, the predefined number stored in the |
| | server is used. |
| <DND ON> | Used to control the do-non-disturb feature on the telephone. |
| <DND OFF> | |

LIST OF EVENTS (Server to client messages)

| | |
|---|---|
| <NEW> name_number | Indicates a new call arriving/alerting the user desk phone. |
| <ANSWER> | Indicates call at desk phone has reached an answered |
| | state. |
| <INFO> text | Used to send an information message to the client. Client |
| | displays the message in a special information box. |
| <IM> text (buddy name | Used to inform client of a change in status of a buddy list |
| and status) | member. Text contains buddy name and new status (“gary |
| | is on line”). |
| <IM_MY_STATUS> | Used to report/confirm a change in the client status. |
| | Returned in response to a <PRES> command, or if some |
| | other activity changes the user presence state. |
| <BUSY> | Used to report that the user desk phone is not idle (activity |
| | in progress). For example if someone uses the desk phone |
| | while the client is at a remote location, this event would be |
| | sent when the phone goes off-hook. |
| <IDLE> | User desk phone has returned to an idle state. |
| <DISP> text | User deskphone display has changed. Updated text is |
| | carried in this message. |
| <MSGON> | Indicates the message waiting lamp on the user desk phone |
| <MSGOFF> | has changed state. Client can use the <MSGCB> command |
| | to connect to the message originator (e.g. phonemail). |
| <FWDON> | Used to indicate a change in call forwarding status on user |
| <FWDOFF> | desk phone. Event generated typically in response to one of |
| | the FWD commands. |
| <PONG> | Response acknowledgment to a PING, to indicate both way |
| | communication possible. |

Standard encryption techniques can be used for improved security, where needed.

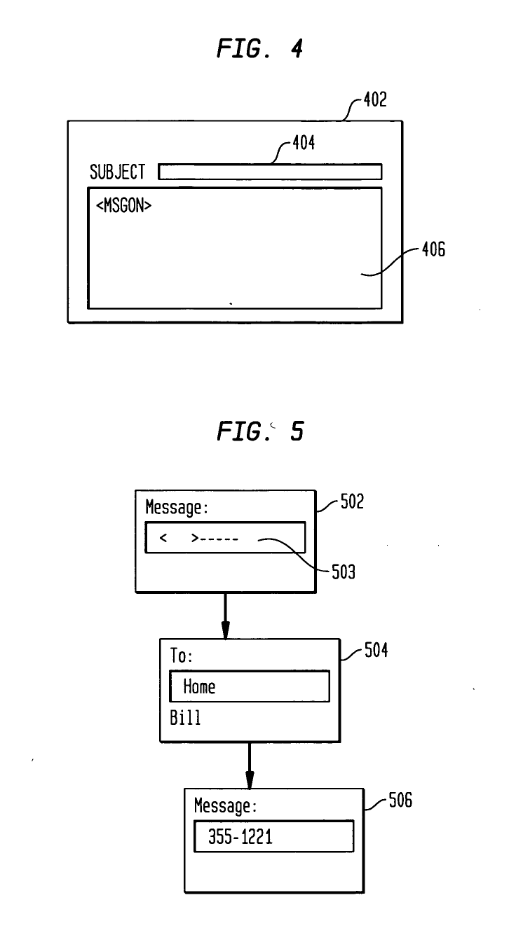

As noted above, in addition to being accessible via the interface of FIG. 3B, the commands may also be typed in and sent via an e-mail interface or by SMS. In the case of an e-mail, the remote e-mail client 112 may generate a mail template and type in the corresponding command. For example, turning to FIG. 4, an exemplary e-mail window 402 is shown. As shown, such a window can include a subject line 404 and a content window 406. In operation, the user can type the desired command into either the subject line or the body, depending on the embodiment. The e-mail client 104a (FIG. 2) then receives the e-mail, identifies it as referring to broker protocol commands, and forwards it to the broker 102, which then translates the text protocol into control parameters for the telephone, presence server, or other server. The e-mail may be identified as a protocol command related e-mail by reading the header or the body, which would include one or more identifiers, such as special text character or characters. If generated and transmitted by the network client 101, then the remote client 112 could display the message and information to the user in similar fashion, or else use an interface such as in FIG. 3.

Similarly, FIG. 5 shows exemplary SMS messaging control using the text-based protocol. A user would typically scroll to an SMS control screen, then type in the message and phone number, then send. Shown at 502 is a message screen in which a user can type the text command 503. The user then selects a destination at 504 and phone number at 506. The phone number may be the user's network client number, or a server number. The SMS client 104 then receives the SMS message, identifies it as referring to broker protocol commands, and forwards it to the broker 102, which then translates the text protocol into control parameters for the telephone or server. Again, if generated by the network client 101, i.e., with the remote client 112 operating in a receive mode, then the remote client 112 could display the message and information to the user in similar fashion on the SMS screen, or else use an interface such as in FIG. 3. If displayed on the SMS screen, one or more special characters may be used to identify the message as referring to text protocol commands.

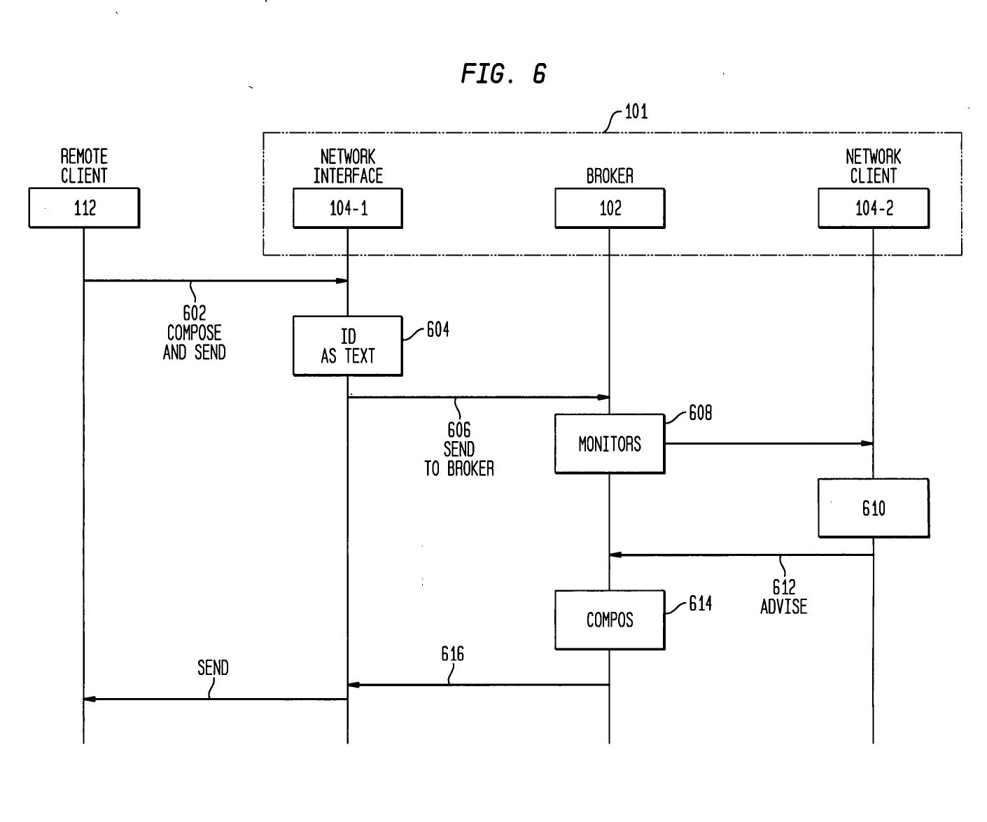

As noted above, an aspect of the present invention relates to using the text-based protocol to monitor a network client from a remote location. Such monitoring can include, for example, receiving presence status updates from a presence server, or indications that a voice message has been received from a voice message system, and the like. This is shown in the signaling diagram of FIG. 6. More particularly, shown are a remote client 112, a network interface client 104-1, broker 102, and a network interfaceclient 104-2. The remote client 112 may be embodied, for example, as any of the clients 112 of FIG. 2. The network interface client 104-1 would typically be the corresponding message receiver/transmitter interface. For example, if the remote client 112 transmits using e-mail, then the network interface client 104-1 would be an e-mail client 104a. The network interface client 104-2 is the monitored client. For example, the monitored client may be a voice messaging system, a telephone, an Instant Messaging system, a presence system, and the like. The condition being monitored could be, for example, reception of a message or identification of a calling party, update of presence information, etc.

Initially, at 602, the user composes the desired command in the appropriate message format and transmits it to the network interface client 104-1 for processing. Alternatively, the user could employ the user interface of FIG. 3B and have the system translate it automatically into the appropriate format. The network interface client 104-1 identifies the message as pertaining to a text protocol control message at 604. For example, in the case of an e-mail message, the subject line could be compared to a list of predetermined subject lines. In the case of an SMS message, a predetermined header or other identifier could be provided. The command message is then provided to the broker 102 at 606, which then decodes the command. At 608, the broker 102 identifies the monitored system and activates monitoring. For example, the broker 102 may determine that the IM/presence system should be monitored for presence updates. At 610, the monitored condition occurs. For example, the IM/presence server could receive an update on the presence status of one or more registered users and provides this information to the client. At 612, the broker 102 is advised or otherwise detects the monitored condition. At 614, the broker 102 composes the information into a message for the remote user. For example, the broker 102 could access a table of templates in the appropriate message format. At 616, the broker 102 sends out the message, where it is received at the remote client 112. As noted above, the message and presence or other update can be sent, for example, using e-mail or SMS.

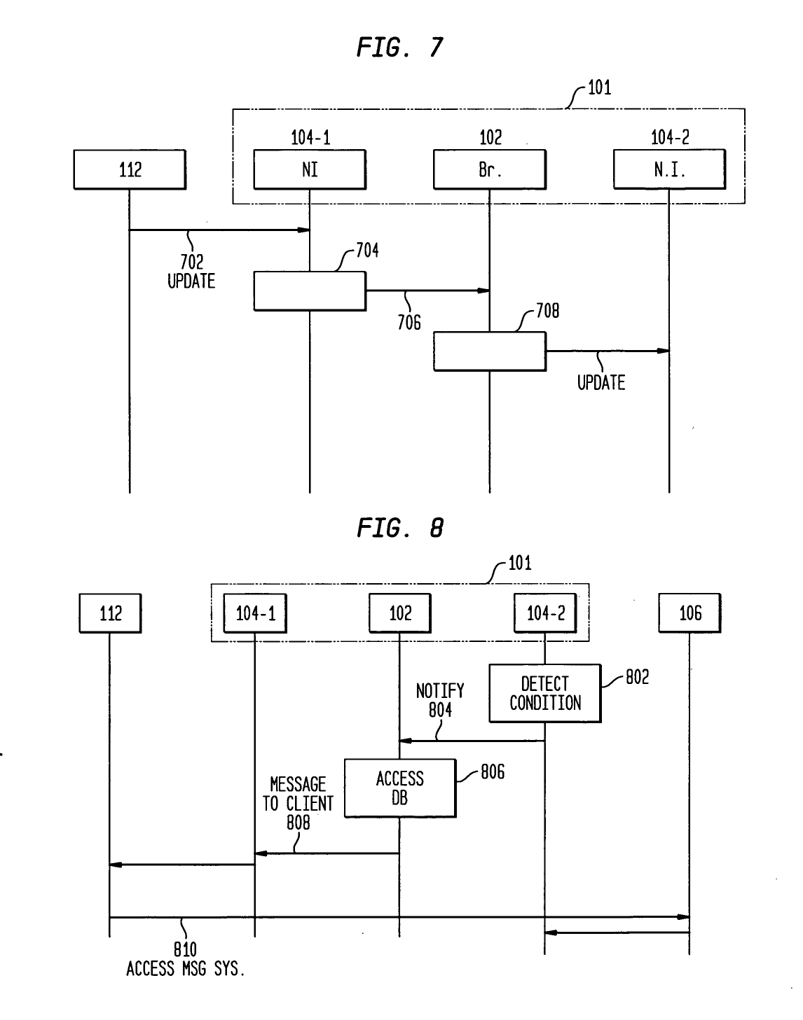

Shown in FIG. 7 is a signaling diagram illustrating use of the present invention to update a system setting at a network client 101. Such settings may include, for example, the user's presence status, answering machine message, etc. More particularly, shown are a remote client 112, a network interface client 104-1, broker 102, and a network interface client 104-2. The remote client 112 may be embodied, for example, as any of the clients 112 of FIG. 2. The network interface client 104-1 would typically be the corresponding message receiver. The network interface client 104-2 is the client whose settings are to be updated. For example, the updated client may be a voice messaging system, a telephone, an Instant Messaging system, a presence system, and the like. The condition being updated could be, for example, call forwarding, presence status, or a voice message, etc.

At 702, the remote client 112 can send an update message, in a manner similar to that discussed above. The network interface client 104-1 receives the message, and identifies it as pertaining to a text-protocol control message, sending it to the broker 102, at 704. At 706, the broker 102 translates the received command and uses it to update the network client interface 104-2, at 708. For example, the broker 102 could provide one or more commands to a presence server, updating the presence status of the user. The presence server would then update, for example, at buddy list at the local client 104-2. The network client 104-2 may then send an acknowledge to the remote client 112 via the broker 102 and interface 104-1.

As noted above, according to an aspect of the present invention, the text-based protocol is used to transmit various control messages, while the public telephone or cellular network is used to establish voice channels. Thus, the text based protocol of the present invention may be used to control telephone functionality, to allow telephone services such as Call, Forward, or accessing an answering machine, as generally described above.

An example of this process is shown in FIG. 8. Shown are a remote client 112, a network interface client 104-1, broker 102, and a network interface client 104-2. The remote client 112 may be embodied, for example, as any of the clients 112 of FIG. 2. The network interface client 104-1 would typically be the corresponding message receiver. For example, the network client 104-2 may be embodied as a voice messaging system. Also shown is telephone system 106.

At 802, a condition, such as a monitored condition, is detected by the network interface client 104-2. For example, the voice messaging system may detect reception of a message and inform the network client 104-2. At 804, the network interface client 104-2 notifies the broker 102 of the condition. The broker 102 then accesses 806 a database (not shown) to determine if the user has a remote client and where it is registered. At 808, the broker 102 sends a corresponding message in the text-protocol to the network client 104-1, which then transmits it at 810 in the appropriate format (e.g., SMS or e-mail) to the remote client 112. The monitored condition can then be displayed, as discussed above, and the user can take actions in response.

If, for example, the network interface client 104-2 is the voice messaging system, then the remote client 112 can then call the voice messaging system via the phone system 106, at 810. The phone system 106 then accesses the voice messaging system at 812.

If the detected condition is an incoming call, then the remote client 112 can decide whether to accept it. If so, then the call can be forwarded to the remote client using known call forwarding techniques.

The invention described in the above detailed description is not intended to be limited to the specific form set forth herein, but is intended to cover such alternatives, modifications and equivalents as can reasonably be included within the spirit and scope of the appended claims.

1. A telecommunications system, comprising:
a wireless packet network;
a cellular telephone network;
a server for interfacing said wireless packet network and said cellular telephone network, said server including a controller adapted to send and receive predetermined text commands suitable for sending over a transport protocol on low speed networks, over said wireless packet network for control of functions of said cellular telephone network, in order to operate the two networks economically as a single coordinated network for voice, status, and control.

2. A telecommunications system in accordance with claim 1, wherein said controller is adapted to send or receive said predetermined text commands as e-mail messages.

3. A telecommunications system in accordance with claim 1, wherein said controller is adapted to send or receive said predetermined text commands as Simple Message Service (SMS) messages.

4. A telecommunications system in accordance with claim 1, wherein said functions include voice messaging status and control functions.

5. A telecommunications system in accordance with claim 1, wherein said functions include presence functions.

6. A telecommunications system in accordance with claim 1, wherein said functions include telephone status and control functions.

7. A telecommunications system in accordance with claim 1, wherein said wireless packet network is a wireless local area network.

8. A telecommunications method, comprising:
interfacing a wireless packet network and a cellular telephone network;
sending and receiving predetermined text commands suitable for sending over a transport protocol on low speed networks,
wherein said sending and receiving comprises sending and receiving over said wireless packet network for control of functions of said cellular telephone network.

9. A telecommunications method in accordance with claim 8, wherein said sending and receiving comprises sending or receiving said predetermined text commands as e-mail messages.

10. A telecommunications method in accordance with claim 8, wherein said sending and receiving comprises sending or receiving said predetermined text commands as Simple Message Service (SMS) messages.

11. A telecommunications method in accordance with claim 8, wherein said functions include voice messaging status and control functions.

12. A telecommunications method in accordance with claim 8, wherein said functions include presence functions.

13. A telecommunications method in accordance with claim 8, wherein said functions include telephone status and control functions.

14. A telecommunications method in accordance with claim 8, wherein said wireless packet network is a wireless local area network.

15. A telecommunications system, comprising:
a wireless network including a wireless voice network, a wireless packet network, and one or more remote clients operably coupled to said wireless voice network and said wireless packet network;
a local area network including one or more function servers and one or more client devices;
wherein said one or more client devices are adapted to receive update and control information from said one or more function servers, translate said update and control information to a text-based protocol, and transmit said update and control information to said one or more remote clients via said wireless packet network; and
wherein said update and control information can be used to access a telephone network from said one or more remote clients via said wireless voice network.

16. A telecommunications system in accordance with claim 15, wherein said update and control information is transmitted via SMS protocol.

17. A telecommunications system in accordance with claim 15, wherein said update and control information is transmitted via e-mail.

18. A telecommunications device, comprising:
one or more network interface clients; and
a communications broker, said communications broker adapted to translate status and control information from said one or more interface clients into a text-based protocol suitable for transmission on a low-speed network; and
wherein said one or more network interface clients is adapted to transmit translated status and control information via a wireless packet network.

19. A telecommunications device in accordance with claim 18, wherein said status and control information is transmitted via e-mail.

20. A telecommunications device in accordance with claim 18, wherein said status and control information is transmitted via SMS.
